(19) United States
(12) Patent Application Publication
(10) Pub. No.: US 2010/0042674 A1
(43) Pub. Date: Feb. 18, 2010

(54) METHOD AND SYSTEM FOR DISCOVERY OF DYNAMIC IP ADDRESSES

(75) Inventors: Brett A. Pantalone, Pittsboro, NC (US); William O. Camp, JR., Chapel Hill, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Nya Vattentornet (SE)

(21) Appl. No.: 12/206,216

(22) Filed: Sep. 8, 2008

Related U.S. Application Data
(60) Provisional application No. 61/089,391, filed on Aug. 15, 2008.

(51) Int. Cl. G06F 15/16

(52) U.S. Cl. 709/203

(57) ABSTRACT

An application program in a host server is operative to detect a change in the host server IP address and, in response thereto, send a message containing the changed address to a remote client, such as a mobile communication device. The message may be transmitted as an email message to a Short Message Server of a cellular provider for the mobile communication device. The message preferably contains at least the changed IP address of the server. The SMS server can identify the phone number of the mobile communication device from the received message and thereby transmit the changed IP address portion of the message to the mobile communication device.

### BACKGROUND

The present invention relates to IP communication, more particularly to remotely tracking dynamic IP addresses of host devices.

With the proliferation of consumer multimedia devices and larger, cheaper memories for storing content, there is a growing desire for consumers to access personal media content from anywhere in the world. In many cases, a consumer stores media content on a personal computer. Storage may include a wide variety of media content such as video, audio, textual, pictorial, and like material, as well as interactive data. With an “always-on” broadband Internet connection, the personal computer is effectively a residential host server that is accessible from remote locations.

Most residential broadband connections utilize DHCP (Dynamic Host Configuration Protocol) to obtain an IP (Internet Protocol) address. Because most Internet Service Providers (ISPs) have more customers than IP addresses, the addresses are typically leased for several days at a time. The IP address of customer equipment is dynamic and subject to change, thereby allowing IP addresses to be recycled. When the lease expires, the customer equipment must request a new address. When equipment is turned off, it forfeits its lease and must obtain a new lease at the next power-up.

If the user is at a remote location and seeks to access the host server from a local computer, portable laptop or mobile communication device, the IP address of the server must be determined. If there is no way for a remote client to determine whether the IP address of the server has changed, unless the original address has been maintained, access to the server will be precluded. Solutions to this problem have been undertaken. Domain Name Servers (DNS) manage a database of permanent host names and their corresponding IP addresses. However, the use of a DNS would require registration with the naming authority and a yearly maintenance fee, which is not acceptable to most consumers. In addition, most ISPs will not maintain DNS server listings for their residential customers.

Another attempt to solve this problem would introduce a proxy server. The home server would report to the proxy whenever it obtains a new lease. The consumer, at the remote location, would contact the proxy server to get indirect access to the home server. Such process would introduce delay and would pad the consumer content with unwanted advertisements. Yet another approach would be to provide network storage that can be accessed by a permanent IP address. The storage space would then incur a subscription fee and would require the consumer to upload content to the third-party server.

The need thus exists for a better way to obtain remote access to a server having a dynamic IP address.

### DISCLOSURE

The above described needs are fulfilled, at least in part, by providing an application program in a host server that is operative to detect a change in the host server IP address and, in response thereto, to send a message containing the changed address to a remote client. The remote client may comprise a mobile communication device. The change in server IP address may be detected by polling the server operating system or a firewall gateway or the like. The gateway may perform network address translation.

The message may be transmitted as an email message to a Short Message Server of a cellular provider for the mobile communication device. The message preferably contains the changed IP address of the server, the telephone number of the mobile communication device and an application tag. The SMS server can identify the phone number of the mobile communication device from the received message and thereby transmit at least the application tag and changed IP address portions of the message to the mobile communication device.

The mobile communication device comprises a memory for storing, in part, IP addresses of one or more host servers. Storage may be in the form of a database that correlates a plurality of host servers with corresponding IP addresses. An application program for managing IP address storage is also contained in the device. The application program is associated with the application tag contained in the message. Upon receipt of the message, the mobile communication device can extract the application tag and the changed IP address. The corresponding application program is then accessed and the stored IP address is changed to the new IP address.

Still other aspects, features, and advantages will be readily apparent to those skilled in this art from the following detailed description, wherein preferred embodiments of the invention are shown and described, simply by way of illustration of the best mode contemplated. The invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1 is a block diagram of a computer system that also may function as a home media content host server;

FIG. 2 is a block diagram of an exemplary client mobile communication device;

FIG. 3 is a block diagram of a system and network for implementing discovery of the IP address of the host server;

FIG. 4 is a flow chart of operation at the home server; and

FIG. 5 is a flowchart of operation of the communication network and client communication device.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments.

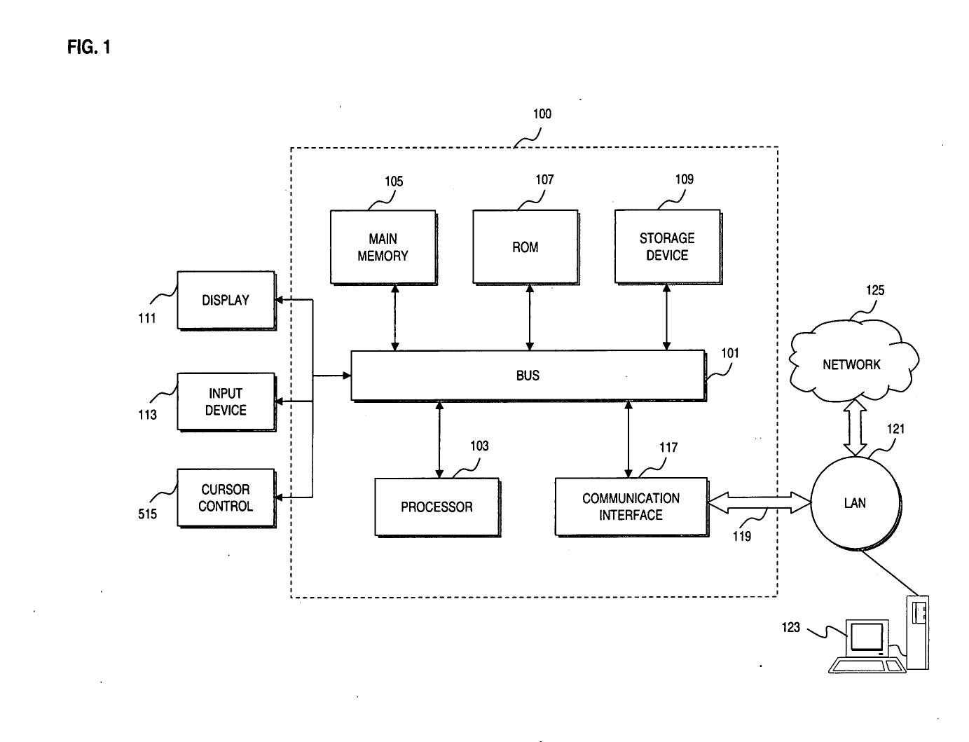

FIG. 1 exemplifies a personal computing system 100 that may be used as a home media content host server. Bus 101, or other mechanism for communicating data, is coupled to processor 103 for processing information. Main memory 105, such as a random access memory (RAM) or other dynamic storage device, is coupled to the bus 101 for storing information. Memory 105 may also store application program instructions to be executed by the processor 103. Main memory 105 can also be used for storing temporary variables or other intermediate information during execution of instructions by the processor 103. Read only memory (ROM) 107 or other static storage device is coupled to bus 101 for storing static information and instructions for the processor 103. A storage device 109, such as a magnetic disk or optical disk, is coupled to the bus 101.

Display 111, such as a cathode ray tube (CRT), liquid crystal display, active matrix display, or plasma display, is coupled to bus 101 for displaying information to a computer user. An input device 113, such as a keyboard including alphanumeric and other keys, is coupled to the bus 101 for communicating information and command selections to the processor 103. Cursor control input 115, such as a mouse, a trackball, or cursor direction keys, is coupled to bus 101 for inputting direction information and command selections to processor 103 and for controlling cursor movement on the display 111.

Processes are performed by computer 100 pursuant an installed operating system in response to execution by processor 103 of an arrangement of instructions contained in main memory 105. Such instructions can be read into main memory 105 from another computer-readable medium, such as the storage device 109. Processor 103 may be representative of one or more processors in a multi-processing arrangement.

Communication interface 117 is also coupled to bus 101. The communication interface 117 provides a two-way data communication coupling to a network link 119 that may be connected to a local network 121. For example, the communication interface 117 may be a digital subscriber line (DSL) card or modem, an integrated services digital network (ISDN) card, a cable modem, a telephone modem, or any other communication interface to provide a data communication connection to a corresponding type of communication line. As another example, communication interface 117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 117 sends and receives electrical, electromagnetic, or optical signals that carry digital data streams representing various types of information. The communication interface 117 can include peripheral interface devices, such as a Universal Serial Bus (USB) interface, a PCMCIA (Personal Computer Memory Card International Association) interface, etc. Although a single communication interface 117 is depicted, multiple communication interfaces can also be employed.

The network link 119 typically provides data communication through one or more networks to other data devices. For example, the network link 119 may provide a connection through local network 121 to a host computer 123, which has connectivity to a network 125 (e.g. a wide area network (WAN) or the global packet data communication network now commonly referred to as the “Internet”) or to data equipment operated by a service provider. Host computer 123 may serve as a gateway to network 125. The computer system 100 can send messages and receive data, including program code, through the network(s), the network link 119, and the communication interface 117. In the Internet example, a server (not shown) can transmit requested code belonging to an application program through the network 125, the local network 121 and the communication interface 117. Alternatively, network 119 may communicate directly with the network 125 in the absence of computer 123 and LAN 121.

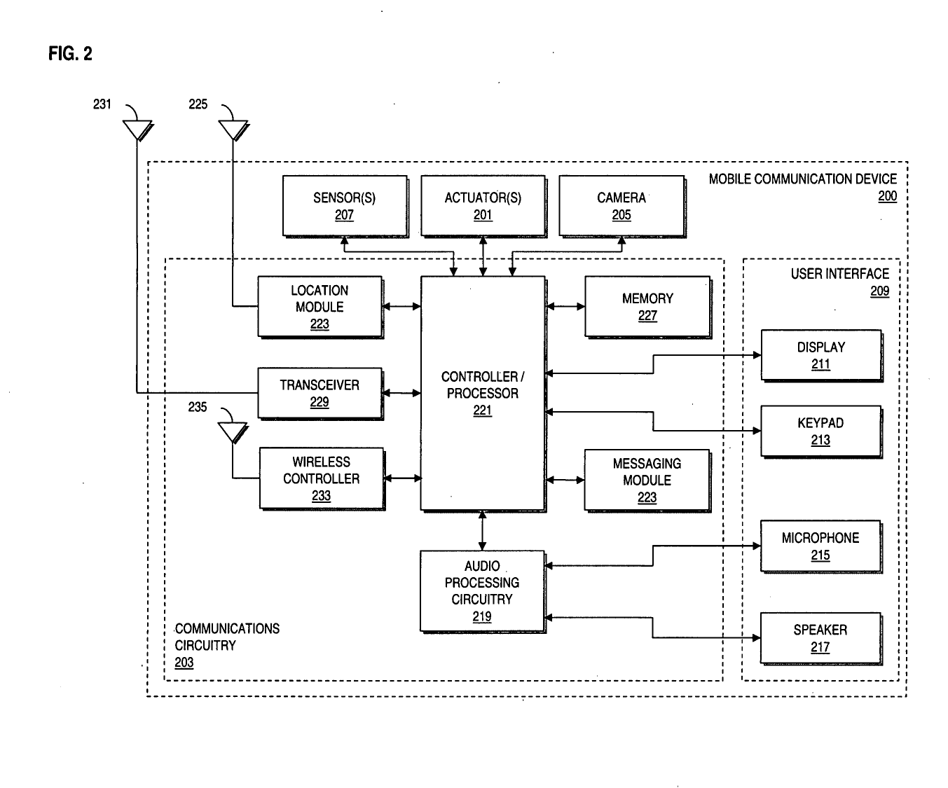

FIG. 2 is illustrative of a client mobile communication device 200, typically a mobile phone. User interface 209 includes display 211, keypad 213, microphone 215, and speaker 217. Display 211 provides a graphical interface that permits a user of mobile communication device 200 to view call status, configurable features, contact information, dialed digits, directory addresses, menu options, operating states, time, and other service information, such as physical configuration policies associating triggering events to physical configurations for automatically modifying a physical configuration of mobile communication device 200. Keypad 213 is representative of conventional input mechanisms, which may also include a joystick, button controls, dials, etc. The graphical interface may include icons and menus, as well as other text, soft controls, symbols, and widgets. In this manner, display 211 enables users to perceive and interact with the various features of mobile communication device 100.

Microphone 215 converts spoken utterances of a user into electronic audio signals. Speaker 217 converts audio signals into audible sounds. Microphone 215 and speaker 217 may operate as parts of a voice (or speech) recognition system. Display 211 and speaker 217 can reproduce media content receive by the device from the host server.

Communications circuitry 203 enables mobile communication device 200 to initiate, receive, process, and terminate various forms of communications, such as voice communications (e.g., phone calls), SMS messages (e.g., text and picture messages), and MMS messages. In other instances, communications circuitry 203 enables mobile communication device 200 to transmit, receive, and process data, such as endtones, image files, video files, audio files, ringbacks, ringtones, streaming audio, streaming video, etc. Communications circuitry 203 includes audio processing circuitry 219, controller (or processor) 221, location module 223 coupled to antenna 225, memory 227, transceiver 229 coupled to antenna 231, and wireless controller 233 (e.g., a short range transceiver) coupled to antenna 235. Controller 221 is also coupled to messaging module 225.

Specific design and implementation of communications circuitry 203 can be dependent upon one or more communication networks for which mobile communication device 200 is intended to operate. For example, mobile communication device 200 may be configured for operation within any suitable wireless network utilizing, for instance, an electromagnetic (e.g., radio frequency, optical, and infrared) and/or acoustic transfer medium. In various embodiments, mobile communication device 400 (i.e., communications circuitry 203) may be configured for operation within any of a variety of data and/or voice networks, such as advanced mobile phone service (AMPS) networks, code division multiple access (CDMA) networks, general packet radio service (GPRS) networks, global system for mobile communications (GSM) networks, internet protocol multimedia subsystem (IMT) networks, personal communications service (PCS) networks, time division multiple access (TDMA) networks, universal mobile telecommunications system (UTMS) networks, or a combination thereof. Other types of data and voice networks (both separate and integrated) are also contemplated, such as microwave access (MiMAX) networks, wireless fidelity (WiFi) networks, satellite networks, and the like.

Also coupled to controller 221 are sensors 207, actuators 201 and camera 205. Camera 205 can capture digital images and/or movies. Image and video files corresponding to the captured pictures and/or movies may be stored to memory 227. The various components of a housing (or casing) of mobile communication device 200 may be physically configured via one or more actuators 201. Sensors 207 may be provided for sensing one or more ambient conditions. Sensors 207 may include various transducers, such as electroacoustic transducers (e.g., microphone, piezoelectric crystal, etc.), electromagnetic transducers (e.g., photodetector, photoresistor, hall effect sensor, etc.) electromechanical transducers (e.g., accelerometer, air flow sensor, load cell, strain gauge, etc.), electrostatic transducers (e.g., electrometer, etc.), thermoelectric transducers (e.g., resistance temperature detector, thermocouple, thermistor, etc.), or radioacoustic transducers (e.g., radio frequency receiver, etc.), etc.

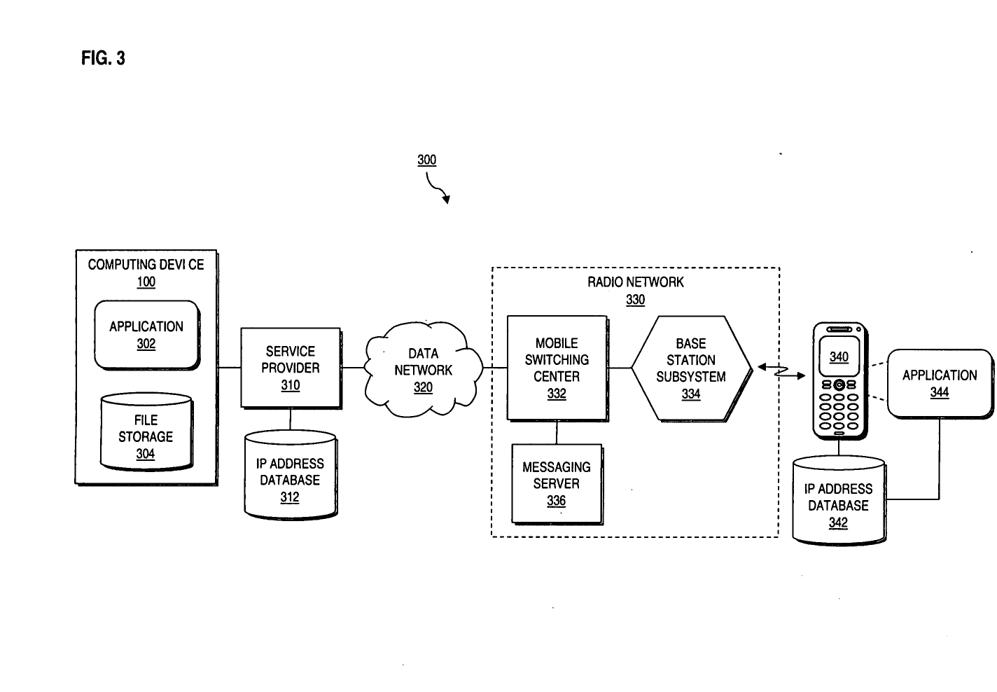

FIG. 3 is a block diagram of a system 300 and network for implementing discovery of the IP address of the host server. Computing device 100, such as the home media content host server of FIG. 1 stores IP address application 302 and file storage 304. Storage 304 contains media content as well as other data. The host server 100 is coupled to data network 320, such as the Internet, via service provider 310. Service provider 310 provides leased IP addresses to the host server allocated on a temporary basis from an IP address pool in database 312. Storage 304, or other storage in the host system, contains the IP address for the named host as allocated by the service provider 310.

Data network 320 is coupled to radio network 330, which may comprise a cellular network for communication with mobile telephone 340. In well known manner, the cellular network includes a plurality of mobile switching centers and base stations having landline connections. The illustrated mobile switching center 332 is a gateway to the data network (or Internet) 320. The illustrated base station subsystem 334 is located within radio range of the mobile communication device 340. An SMS messaging server is coupled to the mobile switching center 332 and is accessible to computer 100 via DNS address lookup.

Mobile station cellphone 340, may comprise elements such as more fully described with respect to FIG. 2. Cellphone storage includes an IP address database 342. The database correlates IP addresses with destination names, including the host server 100. Mobile communication device 340 can be considered to be a client of the host server when accessing the computer 100 for stored content. Additional host servers and associated addresses may also be stored in the database, including servers with permanent IP addresses, as well as servers with dynamic IP addresses. The database may also contain IP addresses linked to destinations in accordance with user input. IP address program application 344 is implemented by the mobile device controller to manage database 342.

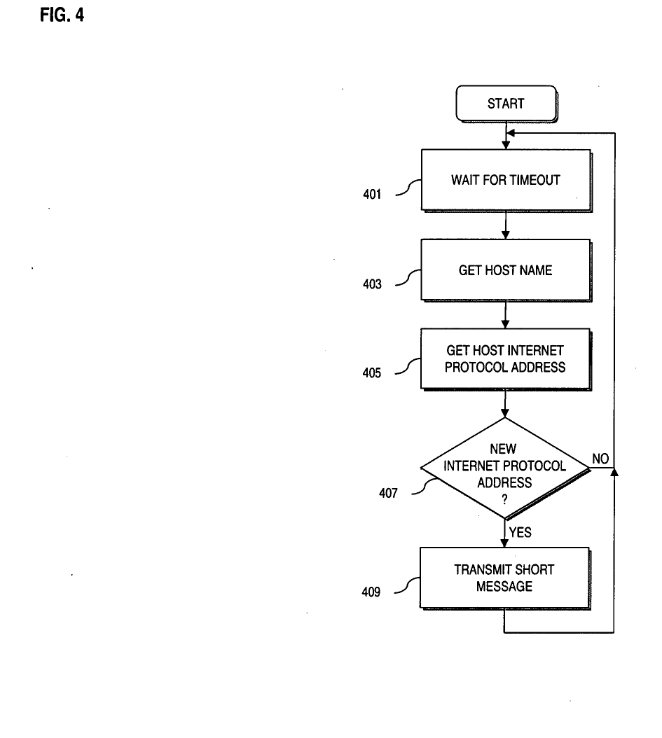

Current identification of the host IP address by the mobile communication device may be maintained as a consequence of the fact that the mobile device is addressable by a permanent phone number, independent of its current IP address, or lack thereof. FIG. 4 is a flow chart of operation of the host server 100 for providing IP address change information. Application program 302 in host 100 is a simple service program that continuously runs and monitors its own IP address. The operating system or residential gateway is periodically polled to get the current host IP address. At step 401, the system waits for the timeout period to expire until it obtains the host name at step 403 and its IP address at step 405. This address is stored for comparison with an IP address obtained in the next polling period.

At step 407, determination is made as to whether the current IP address obtained in step 405 is a new IP address. This determination can be made by comparing the current IP address obtained in step 405 with the address obtained after the previous timeout. If there is no change of address, the process flow reverts to step 401. When a new address has been detected in step 407, the service program sends a short message to the client mobile phone at step 409. An email containing an application tag and the new IP address is transmitted to the cellular provider's SMS server 336. The process flow then returns to step 401 to wait for the next timeout.

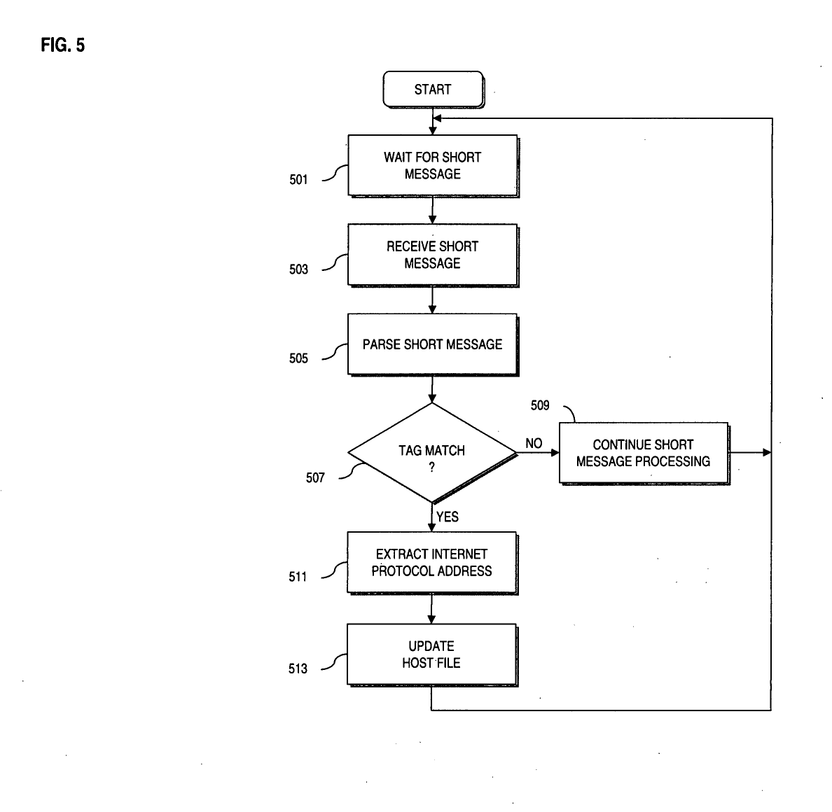

FIG. 5 is a flowchart of operation of the communication network and client communication device for maintaining current host IP address identification. At step 501, the program application 344 in the mobile communication device waits for a short message, which is received from SMS server 336 at step 503. At step 505, the message is parsed. At step 507, determination is made as to whether the message contains an application tag that matches program application 344. Such match is indicative that the host IP address has changed. If there is no application tag match, processing of the SMS message continues in normal fashion and the process reverts to step 501. If a tag match has been detected in step 507, the IP address is extracted at step 511 and the IP address database 342 is updated at step 513. The process then reverts to step 501.

The server's IP address can be stored in a file with a host name. This file is essentially a local version of the DNS by storing host names and their corresponding IP addresses. Once the home server has an entry in the phone's host file, or equivalent database storage, it can be accessed by name, and the correct IP address will be used. Any Internet software on the phone can use this method to connect directly to the server.

Among the advantages of the present disclosure are that there is no use of proprietary protocols as standard SMS protocol is employed. Direct access to content on the residential server is provided. No additional equipment or configuration of the cellular network is required.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein.

What is claimed is:

1. A method comprising:
detecting a change in an IP address of a host server;
in response to the step of detecting, sending a message containing the changed address to a remote recipient.

2. A method as recited in claim 1, wherein the step of detecting comprises polling an operating system.

3. A method as recited in claim 1, wherein the step of detecting comprises polling a host gateway.

4. A method as recited in claim 1, wherein the remote recipient comprises a mobile communication device.

5. A method as recited in claim 4, wherein the step of sending comprises transmitting an email message from the host server to a cellular provider server.

6. A method as recited in claim 5, wherein the cellular provider server is a Short Message Server (SMS), and the email message comprises the changed address of the host server and the telephone number of the mobile communication device.

7. A method as recited in claim 6, wherein the email message further comprises an application tag.

8. A method as recited in claim 6, wherein the step of sending further comprises identifying the phone number of the mobile communication device at the SMS and transmitting the email message from the SMS to the mobile communication device associated with the identified phone number.

9. A method as recited in claim 8, further comprising:
extracting the changed address in the communication device; and
saving the changed address.

10. A method as recited in claim 9, wherein the step of saving comprises storing the changed address in a database containing at least one record correlating a host name to a corresponding IP address.

11. A communication system comprising:
a host server comprising media content storage;
a communication network coupled to the host server; and
a message server coupled to the communication network, the message server configured for communicating short messages to a remote client terminal;
wherein the host server is configured to detect a change in its IP address and transmit a message containing the changed address to the message server.

12. A communication system as recited in claim 11, wherein the remote client terminal is a mobile communication device.

13. A communication system as recited in claim 12, wherein the mobile communication device comprises a database containing a file of at least one host name correlated to a corresponding IP address; and the mobile communication device is configured to update the database in response to receipt of the message.
